(19) United States
(12) Patent Application Publication
(10) Pub. No.: US 2024/0343612 A1
(43) Pub. Date: Oct. 17, 2024

(54) SORBENT COMPOSITIONS WITH NANOBUBBLES IN PRODUCED WATER APPLICATIONS

(71) Applicant: Element3, a dba of Lithos Industries, Inc., Fort Worth, TX (US)

(72) Inventors: Hood H. Whitson, Fort Worth, TX (US); William L. Bourcier, Livermore, CA (US)

(21) Appl. No.: 18/601,898

(22) Filed: Mar. 11, 2024

Related U.S. Application Data
(60) Provisional application No. 63/489,639, filed on Mar. 10, 2023.

(51) Int. Cl. C02F 1/28; C02F 1/00; C02F 103/36

(52) U.S. Cl. CPC C02F 1/281; C02F 1/001; C02F 2103/365; C02F 2209/44

(57) ABSTRACT

Embodiments of the present disclosure may include a method for increasing the efficacy of reducing a concentration of an at least one metal from a volume of produced water, the method including injecting a gas nanobubble into the volume of produced water. Embodiments may also include exposing a volume of produced water infused with nanobubbles to a sorbent composition for a contact time. In some embodiments, the sorbent composition may be a large format composition of at least 150 microns in dimension. Embodiments may also include removing the produced water after the contact time elapses. Embodiments may also include rinsing the sorbent composition after the cycle time. Embodiments may also include exposing the rinsed sorbent composition to a reagent infused with nanobubbles to produce at least one metal eluate.

### PRIORITY CLAIM

The present application claims priority under the Paris Convention Treaty (PCT) to the United States provisional utility patent application No. 63/489,639 titled USE OF LARGE-FORMAT COMPOSITIONS WITH NANOBUBBLES IN PRODUCED WATER APPLICATIONS filed on Mar. 10, 2023.

### TECHNICAL FIELD

The subject matter herein relates, generally, to large-format compositions for extracting a metal from a metal containing fluid, and more particularly, to combining such compositions with nanobubbles in direct metal extraction applications.

### BRIEF SUMMARY

Embodiments of the present disclosure may include a method for increasing the efficacy of reducing a concentration of an at least one metal from a volume of produced water, the method including injecting a gas nanobubble into the volume of produced water. Embodiments may also include exposing the volume of produced water in direct metal extraction applications for a contact time.

In some embodiments, the sorbent composition may be a large-format composition at least 250 microns in dimension. Embodiments may also include removing the produced water after the contact time elapses. Embodiments may also include rinsing the sorbent composition after the cycle time. Embodiments may also include exposing the rinsed sorbent composition to a reagent to produce at least one metal eluate.

Embodiments may also include injecting a gas nanobubble into the volume of produced water may include receiving the volume of produced water. Embodiments may also include injecting a plurality of gas nanobubbles into an aqueous solution. Embodiments may also include mixing the aqueous solution containing the plurality of gas nanobubbles with the volume of produced water.

Embodiments may also include injecting a gas nanobubbles into the volume of produced water or may include using a high-capacity nanobubble system to produce gas nanobubbles in the volume of produced water. Embodiments may also include injecting a gas nanobubble into the volume of produced water or may include injecting a non-buoyant gas bubble. In some embodiments, the non-buoyant gas bubble has a diameter greater than 25 nanometers and less than 250 nanometers.

Embodiments may also include injecting a gas nanobubble into the volume of produced water or may include injecting a plurality of electrochemically active gas bubbles. Embodiments may also include injecting a gas nanobubbles into the volume of produced water or may include injecting oxygen (O₂) gas nanobubbles into the volume of produced water.

Embodiments may also include injecting a gas nanobubble into the volume of produced water or may include injecting air gas nanobubbles into the volume of produced water. Embodiments may also include injecting a gas nanobubble into the volume of produced water or may include injecting carbon dioxide (CO₂) gas nanobubbles into the volume of produced water.

Embodiments may also include injecting a gas nanobubble into the volume of produced water or may include injecting nitrogen (N₂) gas nanobubbles into the volume of produced water. Embodiments may also include a gas nanobubble that may include at least one of an O₂, Air, CO₂, and N₂ gas. In some embodiments, the produced water may be any water produced concurrently with a production of oil and gas hydrocarbons from underground reservoirs or subterranean flows, including, but not limited to naturally occurring formation water, flowback water, recycled water and water injected into reservoirs during hydraulic fracturing or other injection methods.

Embodiments may also include exposing the volume of produced water to a sorbent composition for a contact time or may include batch processing the volume of produced water with the sorbent composition for the contact time. Embodiments may also include exposing the volume of produced water to a sorbent composition for a contact time or may include continuous processing the volume of produced water with the sorbent composition for the contact time.

In some embodiments, the contact time may be a function of at least the volume of produced water, an initial mass of the sorbent composition, and a desired parts-per-million (ppm) removal of the metal. Embodiments may also include a sorbent composition that may be a metal-oxide sorbent. In some embodiments, the metal-oxide sorbent may include a spinel chemical structure.

In some embodiments, the metal-oxide sorbent may be doped with an ion doping agent. In some embodiments, the metal-oxide sorbent may be doped. In some embodiments, the metal-oxide sorbent may be a manganese oxide-based sorbent. In some embodiments, the manganese oxide-based sorbent may be doped.

In some embodiments, the manganese oxide-based sorbent may include a lithium manganese oxide (LMO). In some embodiments, the manganese oxide-based sorbent may include a lithium manganese oxide (LMO)-type lithium ion-sieve (LIS). In some embodiments, the lithium manganese oxide (LMO) may be doped.

In some embodiments, the metal-oxide sorbent may be a titanate sorbent. In some embodiments, the metal-oxide sorbent may be an aluminate sorbent. In some embodiments, the aluminate sorbent may be doped. Embodiments may also include rinsing the sorbent composition with an aqueous solution, wherein the aqueous solution may be at least one of fresh water, deionized water, and a nanobubble-infused water.

Embodiments may also include removing the produced water after the contact time elapses or may include flowing the produced water through a selectively permeable membrane. Embodiments may also include removing the produced water after the contact time elapses or may include treating the produced water. Embodiments may also include treating the produced water, or further including exposing the volume of produced water to a sorbent for a second contact time. Embodiments may also include removing the produced water after the contact time elapses. Embodiments may also include rinsing the sorbent composition after the contact time elapses. Embodiments may also include exposing the rinsed sorbent composition to a reagent to produce at least one metal eluate.

Embodiments may also include removing the produced water after the contact time elapses or may include exposing the volume of produced water to a second sorbent composition for a contact time. In some embodiments, the method may include removing the produced water after the contact time elapses. Embodiments may also include rinsing the second sorbent composition after the contact time. Embodiments may also include exposing the rinsed second sorbent to a reagent to produce at least one metal eluate.

Embodiments may also include removing the produced water after the contact time elapses or may include conducting one or more of a primary separation, a secondary separation, and a polishing filtration. Embodiments may also include rinsing the sorbent composition after the cycle time or may include rinsing the sorbent with fresh water after the contact time.

Embodiments may also include rinsing the sorbent with fresh water after the contact time, the fresh water may include fresh water containing nanobubbles of oxygen (O₂), air, carbon dioxide (CO₂), or nitrogen (N₂) gas. Embodiments may also include exposing the rinsed sorbent composition to a reagent to produce at least one metal eluate or may include returning the fresh water to one or more holding tanks. Embodiments may also include returning the fresh water to one or more holding tanks or may include performing reverse osmosis on the returned fresh water.

Embodiments of the present disclosure may also include a method for increasing the efficacy of reducing a concentration of an at least one metal from a volume of produced water, the method including exposing the volume of produced water to a large-format composition for a contact time. In some embodiments, the large-format composition may be a particle size of at least 150 microns.

Embodiments may also include a Lithium Adsorption step. In some embodiments, the lithium adsorption step may include exposing the volume of produced water to a sorbent composition for a contact time. A large-format composition, such as a lithium manganese oxide (LMO) sorbent may be at least 150 microns in dimension. Embodiments may also include removing the produced water after the contact time elapses. Embodiments may also include lithium adsorption. Embodiments may also include rinsing the sorbent composition with a rinsing agent after the cycle time. In some embodiments, the rinsing agent may be infused with gas nanobubbles. Embodiments may also include a large-format-composition rinse. Embodiments may also include exposing the rinsed sorbent composition to a reagent to produce at least one metal eluate, which may be a large-format-composition elution.

In some embodiments, the rinsing agent may be infused with gas nanobubbles or may be water infused with gas nanobubbles. In some embodiments, the method may include receiving the volume of produced water. In some embodiments, the volume of produced water may be received untreated. In some embodiments, the method may include pre-treating the volume of produced water prior to exposing the volume of produced water to a sorbent composition for a contact time.

Embodiments may also include pre-treating the volume of produced water prior to exposing the volume of produced water to a sorbent composition for a contact time or may include applying, to the volume of produced water, one or more of a mechanical filter, a chemical filter, or a magnetic separation. Embodiments may also include pre-treating the volume of produced water prior to exposing the volume of produced water to a sorbent composition for a contact time or may include applying a plasma treatment to the volume of produced water.

Embodiments may also include pre-treating the volume of produced water prior to exposing the volume of produced water to a sorbent composition for a contact time or may include injecting a gas nanobubble into the volume of produced water. Embodiments may also include rinsing with a rinsing agent after the cycle time or may include rinsing the sorbent composition with fresh water after the cycle time.

In some embodiments, the method may include returning the fresh water to one or more holding tanks. Embodiments may also include rinsing with a rinsing agent after the cycle time or may include rinsing the sorbent composition with fresh water infused with gas nanobubbles after the cycle time. In some embodiments, the method may include returning the fresh water infused with gas nanobubbles to one or more holding tanks. In some embodiments, the method may include performing at least one of reverse osmosis and forward osmosis on the returned fresh water. Embodiments may also include aiding the reverse osmosis and/or forward osmosis on the returned fresh water with gas nanobubbles to support the separation of the metal from the eluate.

Embodiments of the present disclosure may include a method for increasing the efficacy of removing a metal from a sorbent composition containing the metal of interest.

This method may involve introducing a volume of nanobubble gases into a fluid comprising at least a reagent and the sorbent containing the metal of interest for a defined contact time. During this period, the metal of interest substantially vacates the sorbent into the fluid, thereby creating a metal-containing fluid. Embodiments may also include separating the metal-containing fluid from the sorbent after the contact time elapses.

In some embodiments, the method may further comprise releasing the metal-containing fluid to reverse-osmosis equipment. This release may additionally include introducing nanobubbles into the metal-containing fluid, wherein the nanobubbles enhance the reverse-osmosis equipment's ability to recover a reverse-osmosis permeate and further concentrate the metal within the metal-containing fluid. The metal addressed in these embodiments may be a metal salt.

Embodiments of the sorbent composition containing the metal of interest may include, but are not limited to, lithium manganese oxide (LMO) spinel, LMO-type lithium ion-sieve (LIS), doped LMO, titanate sorbent, doped titanate sorbent, aluminate sorbent, and doped aluminate sorbent.

A system for increasing the efficacy of removing a metal from a sorbent composition containing the metal of interest is also disclosed. This system may comprise a nanobubble gas unit for introducing a volume of nanobubbles into a fluid and a tank for mixing the fluid and the sorbent composition for a predetermined contact time, facilitating the metal's transfer from the sorbent to the fluid.

In certain embodiments, the system may include a reverse osmosis station configured to receive the metal-containing fluid post-contact time. This station may perform dual functions: removing water from the metal-containing fluid to increase the metal's concentration and optionally incorporating nanobubbles into the metal-containing fluid to enhance metal recovery and concentration efforts.

Further embodiments of the system may cater to configurations wherein the metal of interest is a critical earth metal. Additionally, the sorbent composition may be specifically designed to include various forms of lithium manganese oxide and titanate sorbents, among others. A selectively permeable membrane to facilitate the flow of nanobubbles into the fluid may also be included in some embodiments.

Embodiments may extend to a system designed to increase the efficacy of reducing the concentration of at least one metal of interest from a volume of a metal-containing fluid. This system can feature a gas nanobubble injector to introduce gas nanobubbles into the fluid and a metal extraction unit. The metal extraction unit operates in the presence of the injected gas nanobubbles, isolating the metal of interest for efficient extraction. This unit may further comprise a membrane system for enhanced performance.

### BRIEF DESCRIPTION OF THE FIGURES

FIG. 1 is a diagram of a system configured to reduce a concentration of at least one metal from a produced water source according to some embodiments of the present disclosure.

FIG. 2 is a flowchart illustrating a method for increasing the efficacy of reducing a concentration of an at least one metal from a volume of produced water, according to some embodiments of the present disclosure.

FIG. 3 is a flowchart further illustrating the method for increasing the efficacy from FIG. 2, according to some embodiments of the present disclosure.

FIG. 4 is a flowchart further illustrating the method for increasing the efficacy from FIG. 2, according to some embodiments of the present disclosure.

### DETAILED DESCRIPTION

In a departure from conventional sorbent formats which are traditionally fine-grained, in some embodiments, the present disclosure describes the use of large-format compositions, often 250 microns or larger, to be used to remove metals from produced water. In some embodiments, the large-format compositions may be sorbents, spinels, sorbent-containing spinels, and other ion-exchangers of sufficient size to support the removal of metals from produced water, and whose size facilitates the extraction of the large-format composition itself from aqueous solutions used in the process. While these large-format compositions accelerate direct metal extraction in higher temperatures, increases in temperature and pressure common with direct extraction, adsorption, and absorption techniques are not required for removing metals from produced water.

The present disclosure also discloses the use of nanobubbles to facilitate direct metal extraction from a variety of subsurface brines. Sources of subsurface brines containing metals of interest are numerous; nonlimiting examples of which include brines associated with the oil and gas value chain, geothermal applications, conventional salar brine mining and the like. Such brines may contain metals that may be extracted or more effectively extracted when the extraction process is augmented with the use of gas nanobubbles. For examples of brines containing metals, see Pistilli, Melissa. “Types of Lithium Brine Deposits.” INN, 14 Jan. 2023, https://investingnews.com/daily/resource-investing/battery-metals-investing/lithium-investing/lithium-deposit-types-brine-pegmatite-and-sedimentary/, which is incorporated herein in its entirety by reference.

The present disclosure describes systems and methods that use nanobubbles to isolate a desired metal within a metal-containing fluid. The introduction of nanobubble gases into the metal containing fluid, may enhance the separation and concentration of metals from metal containing fluids, like produced water. Some systems for using nanobubble gases may inject a volume of nanobubble gases into a metal containing fluid that contains both the sorbent with the metal of interest and a reagent. While some systems may use a sorbent, such as an LMO, use of nanobubbles in combination with sorbents are illustrative and not intended to be limiting. Nanobubbles, due to their size, often neutral buoyancy, and high surface area to volume ratio, provide unique physicochemical properties useful in direct lithium extraction systems. For instance, the large surface area of nanobubbles facilitates more extensive contact with the metal ions present in the fluid, enhancing the interaction between the nanobubbles and the metal with or without a sorbent.

During the contact time between a metal within a sorbent structure and nanobubble gas, the metal, typically in ionic form, is encouraged to vacate the sorbent and enter the fluid, creating a metal-containing fluid. This migration may be facilitated by the action of the nanobubbles, which can alter the chemical environment around the sorbent, making it more conducive for the metal to dissociate from the sorbent and become soluble in the fluid.

Further processing of the metal-containing fluid can be performed using reverse-osmosis equipment. Introducing nanobubbles into this fluid before or during the reverse osmosis process can significantly improve the equipment's efficiency. The presence of nanobubbles may help in two main ways: first, by enhancing the recovery of reverse-osmosis permeate, and second, by further concentrating the metal within the metal-containing fluid. This may be achieved because nanobubbles can reduce the osmotic pressure and increase the mass transfer across the reverse osmosis membrane, leading to a more effective separation process. In some embodiments, the desired metal is not only separated from the sorbent but is also concentrated within the fluid. The process may isolate the metal, making it easier to extract and purify for further use. Alternatively, nanobubbles facilitate the concentration of the metal within the metal containing fluid, by supporting the removal of at least some of water within the metal containing fluid. The method is particularly beneficial for metals in salt form, such as those created by exposing the metal of interest within the fluid to an acid. In some embodiments, the metal of interest may include critical earth metals or sorbent compositions like lithium manganese oxide (LMO) and its variants.

The present disclosure also supports the use of nanobubbles when processing a variety of liquid resources to extract metals contained therein. A liquid resource can be broadly defined as a natural brine, a dissolved salt flat, seawater, concentrated seawater, a desalination effluent, a concentrated brine, a processed brine, an oilfield brine, a liquid from an ion-exchange process, a liquid-from-a-solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.

While subsurface brines and liquid resources are described, water produced from oil and gas activities also often contain metals of interest in their ionic form. Produced water is generally defined as any water produced concurrently with the production of oil and gas hydrocarbons from underground reservoirs or subterranean flows, including but not limited to naturally occurring formation water, flowback water, recycled water and water injected into reservoirs during hydraulic fracturing or other injection methods. In some embodiments, the present disclosure may be utilized to extract a metal or metals of interest from a recycle pit or other holding tank or pond on the surface.

While the present disclosure includes references to produced water in the forgeoing examples, the presence of metals in brines, the chemical properties of brines, and the usefulness of gas nanobubbles for treating brines and supporting direct metal extraction make the present disclosure applicability to a broad range of industries.

The present disclosure is useful to a variety of technical fields, including geothermal, water treatment, and oil and gas fields. In one non-limiting example, existing hydrocarbon extraction processes from oil and gas yield produced water containing valuable metals. Such applications of directly extracting the ionic form of metals from the produced water benefit from the use of nanobubbles in several ways. The disclosure can be applied across all stages of oil and gas recovery. In some embodiments, the present disclosure may be applied to primary recovery, where a well is drilled for hydrocarbon either vertically or horizontally. Upon well completion, in certain geographical areas and producing zones, natural water flow is sufficient in quantity and with viable concentrations of valuable materials for the application of sorbent compositions to be used to extract metals. In some embodiments, the water may first be pre-treated, for example by using membrane systems to remove solids, colloidal silica, oil, and some heavy metals, and then fed through a skid placed on site to extract a metal of interest (e.g., lithium). For examples of metals, see “U.S. Geological Survey Releases 2022 List of Critical Minerals: U.S. Geological Survey.” U.S. Geological Survey Releases 2022 List of Critical Minerals|U.S. Geological Survey, https://www.usgs.gov/news/national-news-release/us-geological-survey-releases-2022-list-critical-minerals, incorporated herein by reference, to the extent not inconsistent herewith. In some embodiments, the process may continue in either batch or continuous flow to fully separate the materials from the produced water. In some embodiments, membrane systems used for liquid filtration in a pre-treatment process may include novel ceramic membranes. Ceramic membranes may be used to separate mixtures of gases and or liquids. See A. J. Burggraaf, K. Keizer, Ceramic Membranes, Editor(s): RJ BROOK, Concise Encyclopedia of Advanced Ceramic Materials, Pergamon, 1991, Pages 62-67, ISBN 9780080347202, https://doi.org/10.1016/B978-0-08-034720-2.50027-7; and Shriram Sonawane, Parag Thakur, Shirish H. Sonawane, Bharat A. Bhanvase, Chapter 17-Nanomaterials for membrane synthesis: Introduction, mechanism, and challenges for wastewater treatment, Editor(s): Bharat Bhanvase, Shirish Sonawane, Vijay Pawade, Aniruddha Pandit, in Micro and Nano Technologies, Handbook of Nanomaterials for Wastewater Treatment, Elsevier, 2021, Pages 537-553, ISBN 9780128214961, https://doi.org/10.1016/B978-0-12-821496-1.00009-X. The present disclosure may similarly be applied to secondary recovery, where techniques are applied to extend the productive life of a well by injecting water or gas to displace oil and drive it to a production wellbore, resulting in the recovery of 20 to 40 percent of the original oil in place. In these instances, the present disclosure may be applied to the recovered produced water, thereby increasing the flow of these valuable materials and creating efficiencies in direct metal extraction. A skid, or in some embodiments multiple skids, may be placed on-site to recover materials from the produced water.

Lastly, in a tertiary recovery methodology, the present disclosure may be utilized to drill or recomplete/redrill and extend plugged and closed well bores that no longer produce hydrocarbons in producing and paying quantifies. In this instance, once wells have been deemed insufficient for the economic recovery of oil and gas and other hydrocarbons—the present disclosure may open an entirely new resource out of abandoned well bores.

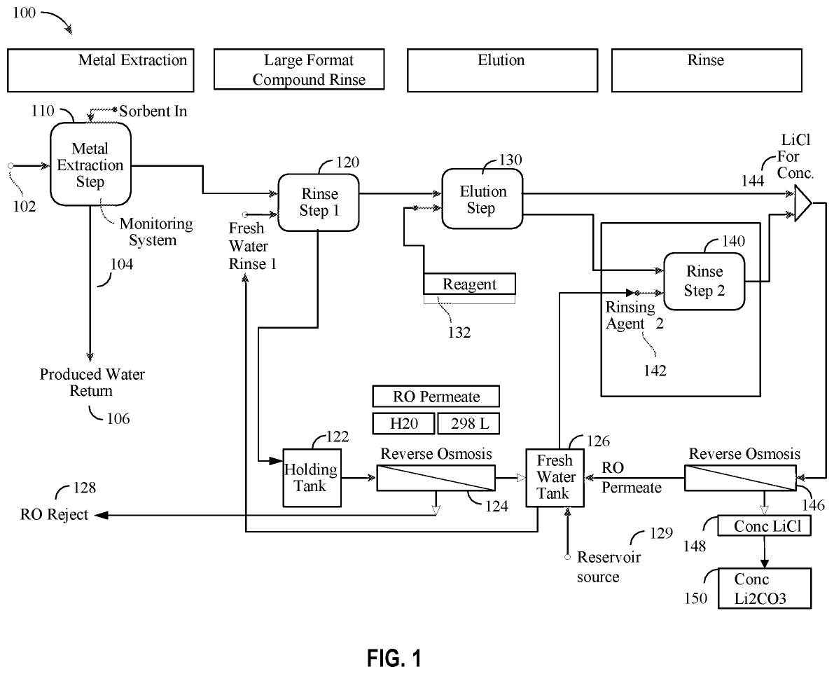

FIG. 1 is an exemplary system 100 configured to extract a desired metal from a volume of produced water, according to some embodiments of the present disclosure. For a discussion of direct lithium extraction systems, see Putro, Cahyo & Anderson, Corby. (2022). INVESTIGATION OF FACTORS AFFECTING DIRECT LITHIUM EXTRACTION WITH ION EXCHANGE; hereby incorporated by reference. The system 100 depicts four phases that may be implemented to extract a metal from produced water. The first step, the metal extraction step 110, may include receiving produced water 102 into the system 100. Receiving the produced water 102 may include moving the produced water from a storage station, a shipping container, or a well using a gravity feed, a pump system, or siphon mechanism to a batch or continuous processing system 100. Alternatively, in some embodiments, receiving the produced water 102 may include receiving the produced water from a transportation vehicle (e.g., a tanker, a rail car). In some embodiments receiving the produced water 102 may include receiving the produced water from a fixed assembly, such as a pipeline. In some embodiments, the produced water 102 is infused with nanobubbles, which can support the removal of oil, flocculants, hydrogen sulfide, solid iron precipitants, and the like present in the produced water. Removing oil and other chemicals may increase the period during which a sorbent composition, such as a spinel, can directly extract a desired metal in the metal extraction step 110. The system 100 may be configured to process a volume of produced water measured in various volumes and may accommodate a variety of concentrations of metal. Accommodating a variety of concentrations of metals may be necessary when extracting metal from produced water, as the concentrations of metal diminish, sometimes predictably, over the life of a well. In some embodiments, the system may pre-process or otherwise pretreat the produced water 102 prior to the metal-extraction step 110 (not depicted). While produced water has been provide as one non-limiting example, the aforementioned principles are applicable to subsurface brines and liquid resources. In some embodiments, the continuous processing system 100, the liquid resource may be a natural brine, a dissolved salt flat, seawater, concentrated seawater, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.

In some embodiments, the metal-extraction step 110 is aided by the use of a sorbent composition capable of extracting metals, for example metals in ionic form within the produced water. In some embodiments, a large-format composition, for example an LMO sorbent greater than 100 microns, may be scaled up to accommodate volumes of produced wastewater over 10,000 barrels. While the present example details the use of a large-format composition and sorbent composition, smaller format sorbents, doped sorbents, undoped sorbents, coated sorbents, uncoated sorbents, and combinations thereof may be used to adsorb a desired metal from the metal containing fluid. Large-format compositions may process more than 33,122 liters per contact with a thirty-minute contact time. Contact time may be varied depending upon the amount of desired metal to be extracted. The amount of desired metal may be arrived at using various methods, for example by the desired mass of recovered metal or as measured in the reduction of the concentration of the desired metal from the metal containing fluid (e.g., a brine). Contact time may also be influence by the extraction technology used.

The metal extraction step 110 may use technology alternatives outside of format compositions (e.g., LMO sorbents) such as Electrochemical Extraction, Ionic Liquid Extraction, Membrane Technologies, Solvent Extraction, and Precipitation and Crystallization where the use of nanobubbles in these systems may aid the metal extraction process. While several technologies have been discussed, different types of metal producing waters and metals sought for extraction may necessitate the use of one or more of the aforementioned technologies. The system 100 may use batch-processing or continuous-processing techniques to run as many as 48 contacts prior to exhausting the large-format composition. In some embodiments, the contact time may be tuned to account for the initial concentration of metal within the produced water 102 to ensure sufficient contact with the large-format composition, e.g., an ion-exchange media, has sufficient contact time to remove the desired volume (or other unites such as mass) of metal from the produced water. To perform the metal extraction step 110, the system 100 may be configured with a monitoring system 104 to monitor the change of metal concentration. The monitoring system 104 may be equipped with a CPU, peripheral devices such as a temperature sensor, a pH sensor, and sensors of other chemical-properties-and-contents sensors that may be used to characterize the contents and nature of the produced water. In some embodiments, the monitoring system 104 may monitor the duration of the contact time, the contact time, the volume of produced water in the system, the count of elapsed contact times, the status of equipment (e.g., the health of equipment, a maintenance status, the active or inactive status of equipment), and visual and/or audible indicators to alert a user to take action. The CPU may be connected to an internet or a local network to send status updates of the system. For example, as a large-format composition, for example, a sorbent, approaches the end of its useful life, the CPU of the digital monitoring system may create an alert and transmit the alert to a user interface so the sorbent may be replenished at an appropriate time.

In some embodiments, the produced water is removed 106 during or after the metal-extraction step 110. In some embodiments, the produced water may be actively removed using an appropriate mechanism that sequesters the large-format composition from the produced water. The produced water 106 may also be further processed to extract additional metals in a staged continuous-extraction process. In an alternative embodiment, the produced water may be transferred to another portion of the system 100 adapted to extract a second metal, pollutant, or to administer a treatment prior to returning the produced water for transport to an alternative site.

In some embodiments, the large-format composition, laden with the metal, may undergo a rinse step 120. In some embodiments, the rinse step 120 may use a rinsing agent, for example, fresh water, to remove remaining produced water from the large-format composition. In some embodiments, a fresh-water rinsing agent of 331 liters may be used to ensure the large-format composition is sufficiently free of produced water. In some embodiments, the properties of the large-format composition may be used to separate the large-format composition from the produced water in the rinse step 120. For example, removing the produced water 106 from the large-format composition, such as an LMO, may involve applying a magnetic field to use the magnetic properties of the LMO to concentrate the large-format composition for removal. In some embodiments, the rinsing step 120 may be aided by applying backpressure or a vacuum to the system. While discussed with respect to the rinse step 120, the described techniques may be applied to remove the large-format composition from produced water, reagents, and any aqueous mediums used in the system 100.

Upon completion of the rinse 120, the fresh water may be removed and stored in a holding tank 122. In some embodiments, the rinsing agent may be processed to remove pollutants prior to returning the rinsing agent to a holding tank. In some embodiments, the holding tank 122 may be adapted to use back pressure or a vacuum. In some embodiments, the rinsing agent may be transferred to a reverse-osmosis unit 124 to remove the water for storage in a freshwater tank 126. The RO unit reject 128 may be removed from the system 100 in some embodiments. In some embodiments, the system 100 may include monitoring equipment to detect water levels in the freshwater tank 126 and may include a freshwater reservoir source 129 to replenish the freshwater tank 126.

In some embodiments, the large-format composition containing the metal of interest is exposed to a reagent 132 in an elution step 130. In some embodiments, the reagent 132 may be an acid, for example, hydrochloric acid (HCl) or sulfuric acid (H₂SO₄). In an embodiment in which the metal of interest is lithium, exposure of the large-format composition to the reagent, for example, an acid like HCl, will produce LiCl, allowing the LiCl to be subsequently removed from the large-format composition. While the synthesis of the metal salt lithium chloride has been provided, the acid may be varied to produce the metal salt of choice. For example, use of sulfuric acid (H₂SO₄) may be a preferred reagent when the metal salt lithium sulfate (Li₂SO₄) is desired. Of note, the reagent 132 may be mixed in various concentration levels. Once the metal has reacted with the reagent 132, a rinsing agent 142 may remove the desired metal from the sorbent. In some embodiments, the holding tank 122 may be adapted to use back pressure or a vacuum to support the removal of the desired metal from the sorbent. In some embodiments, the rinsing agent 142 is fresh water. Using fresh water allows the metal in its ionic form to be contained within the water. In some embodiments, the LiCl is concentrated within the rinsing agent.

In some embodiments, the direct metal-extraction process may continue by further processing the concentrated metal salt 144 created by the reverse-osmosis process 146 into an alternative chemical composition. In some embodiments, the metal salt 144 may be lithium chloride and a processing step 150 may convert the lithium chloride into lithium carbonate. In some embodiments, the processing step 150 may utilize conventional techniques for processing the metal salt to an alternative metal composition. See Canadian patent number CA 3158831 A1, titled “Production of Lithium Hydroxide and Lithium Carbonate” incorporated in its entirety by reference. Such techniques produce lithium carbonate from lithium chloride, water, and a carbon source. In some embodiments, the carbon source is provided by producing carbon-dioxide nanobubbles in the water.

In some embodiments, the system 100 may be delivered on site to extract metals in ionic form from a metal-containing fluid (e.g., one or more of a subsurface brine, produced water 102, and liquid resources). In such an embodiment, the system 100 may be placed on an easily shippable skid and placed onsite, allowing for a rapidly deployable and customizable solution for extracting metals that does not disrupt other onsite operations. In some embodiments, infrastructure, such as piping with optional valves, allow the metal-containing fluid to be received at a first vessel where the metal-extraction step 110 may be performed. When batch processing is used, the first vessel for performing the metal-extraction step 110 may include a valve for releasing metal-containing fluid from the first vessel once a cycle time of exposure to the large-format composition, or conventionally sized sorbent/spinel, and nanobubbles has elapsed. The skid system 100 may also contain a second vessel containing a rinsing agent plumbed to the first vessel for performing the metal-extraction step 110.

Upon releasing the metal-containing fluid from the first vessel, the rinse step 120 may be performed, allowing the fluid to be washed from the large-formation composition, or conventionally sized sorbent/spinel. In some embodiments the skid system 100 may contain a third vessel plumbed to the first vessel for performing the metal extraction 110 and/or rinse step 120. The third vessel may contain a reagent. In some embodiments, the reagent stored within the third vessel is released into the first vessel to release the metal contained within the large-format composition, or conventionally sized sorbent/spinel into a fluid containing the reagent (e.g., the elution step 130). The skid system 100 may be adapted for continuous or batch processing. In some embodiments, the skid system 100 includes at least plumbing and (sometimes necessary) fluid-storage vessels to complete a metal-extraction step 110, a rinse step 120, and an elution step 130. In some environments, a second rinse step 140 may not be needed. In some embodiments, the skid system 100 may be adapted with a forward-osmosis system (e.g., when fresh water is plentiful) or a reverse-osmosis system 845 (e.g., when fresh water is more scarce and on-site water recovery is desired to support direct metal extraction or other on-site needs).

In some embodiments, the skid system 100 may be further adapted to environmental conditions in other ways. For example, additional equipment may be co-located or otherwise installed on the skid to support the rinse step 120. A holding tank 122 may be connected to a forward osmosis system or a reverse osmosis system 146. In some embodiments, the forward-osmosis system or the reverse-osmosis system 146 may be plumbed to a freshwater tank 126. The freshwater tank 126 may be used to support the rinse step 120, and/or optionally provide a water source for a second rinse step 140. In some embodiments, the reverse-osmosis unit 124 may be augmented or replaced with a filtration system (e.g., a nanofiltration system, an ultrafiltration system, or another water-filtration system such as a distillation or deionization system) to clean the rinse of the rinse step 120.

In some embodiments, the system 100 is augmented or adapted at 146 with systems for further concentrating the metal-salt eluate 144. While the system 100 is depicted with a reverse-osmosis unit 146, in some embodiments, the reverse-osmosis unit may be replaced with or augmented with an industrial evaporator, such as one or more of the Saltworks™ product line of saltmaker evaporators. In an alternative embodiment in which energy sources are not plentiful, further concentrating the metal-containing eluate may be accomplished in an evaporation pond.

In some embodiments, the skid system 100 may be further adapted with equipment to convert a metal salt to an alternative chemical composition (e.g., lithium chloride to lithium carbonate). In some embodiments, the skid system 100 includes a nanobubbles pump for injecting carbon dioxide into an eluate containing the concentrated metal salt.

In some embodiments, the system 100 may include valves and equipment capable of being controlled by a monitoring system 104. The monitoring system 104 may contain a CPU having instructions for requesting sensor information collected by peripheral sensors and/or devices connected to the monitoring system 104. In some embodiments, peripheral sensors may be hardwired to the monitoring system 104 or wirelessly connected to the monitoring system 104. In some embodiments, wirelessly connected peripheral sensors and/or devices directly communicate through the wireless network to the monitoring system 104 and/or communicate through a network router to a local, remote, or otherwise cloud-based monitoring system 104.

The monitoring system 104 may track or otherwise sense the chemical properties of the produced water 102, detect the amount of sorbent in the metal-extraction step 110, and/or track the contact time of the produced water 102 with the sorbent. In some embodiments, the sensed information may be used to automatically start pumps or open valves used to remove the produced water 106. In some embodiments, the monitoring system 104 may selectively control a nanobubbles pump. For example, the nanobubbles pump may be activated, creating gas nanobubbles in the produced water or brine to increase the effectiveness of the sorbent to extract the metal. In some embodiments, the monitoring system 104 may be configured to utilize algorithms capable of improving, even optimizing, the use of nanobubbles for the extraction of the metal.

In some embodiments, the CPU further contains instructions for initializing the rinse step 120. In some embodiments, the monitoring system 104 may initialize the rinse step 120 upon detecting the removal of the produced water to a produced water return 106. In an alternative embodiment, the monitoring system 104 may monitor the changing properties of the produced water 102 as the desired metal is extracted. For example, when lithium ions within the produced water 102 are sequestered within a large-format composition, for example a large-format spinel of LMO, the pH of the produced water becomes more acidic as the lithium-ion concentration decreases in the produced water 102. Such a phenomenon, e.g., a changing property of the produced water 102, may be monitored by the monitoring system 104, and upon the changing property of the produced water 102 reaching a state indicative of an extraction level of the lithium ion, the produced water may be removed and the rinse step 120 initiated. For example, a volume of produced water containing 200 ppm levels of lithium may have an initial pH of 8.8. Upon reducing the ppm levels of lithium to roughly 13 ppm, the pH may become more acidic achieving a pH of 6.1. In an alternative embodiment, the monitoring system 104 may contain instructions that when executed by the CPU cause a magnetic field to be applied to a container where the metal-extraction step 110 has taken place. The activation of a magnetic field benefits from the inherent magnetic properties of certain sorbents and large-format compositions. For example, the application of the magnetic field may attract a sorbent such as an LMO spinel to aggregate on a surface of the container when the produced-water return 106 receives a command/instruction to open.

In an embodiment in which the system 100 is placed on a mobile skid, the state information related to the metal-extraction step 110, the rinse step 120, and other activities such as the elution step 130, may be transmitted to remote users monitoring the extraction process depicted in FIG. 1.

In some embodiments, the monitoring system 104 may monitor the quality of the aqueous solution used to perform the rinse step 120. In some embodiments, nanobubble pumps may be activated to aid in a forward-osmosis process or reverse-osmosis process 124. The use of nanobubbles may accelerate the ability to separate the water from other chemicals present as a result of the rinse steps 120 and 140. Similarly, the monitoring system 104 may actively sense the presence of rinsing agents, the quality of the rinsing agents, the presence of the rinsing agents, the chemical composition of the rinsing agents, and the current state of the rinsing agents as indicated by one or more parameters of the rinsing agents such as a temperature, pressure, pH, and the like. Such information may be communicated to a user, for example, over a private local area network (LAN). In some embodiments, the monitoring system 104 may be adapted with an ethernet port, cellular antennae, or other wireless communications equipment for transmitting and receiving status information to local and remote users.

In some embodiments, the monitoring system may include instructions that when executed cause the release of a reagent 132 to the rinsed sorbent containing the metal of interest. The release may activate or otherwise open a valve separating a reagent tank (not depicted) from a tank where the elution step 130 takes place. In some embodiments, the rinse step 120 and elution step 130 occur in the same tank. The monitoring system 104 may contain sensors able to monitor the molar concentration of the reagent 132. In some embodiments, the system 100 may include multiple reagents tuned to the metal sought to be extracted from the sorbent. In some embodiments, the elution step 132 of the system 100 may be adapted with equipment for producing nanobubbles to speed up or otherwise enhance the elution step 130. In some embodiments, the monitoring system may include instructions that when executed cause the nanobubble equipment to produce nanobubbles of different or varied gas types. In some embodiments, the monitoring system 104 may monitor the effectiveness of the nanobubbles in producing a metal salt, such as lithium chloride.

In some embodiments, the monitoring system may include instructions that when executed cause the system 100 to conduct a second rinse step 140. The second rinse step 140 may be initiated by releasing a rinsing agent 142. In some embodiments, the monitoring system may include instructions that when executed cause the system 100 to release a concentrated metal salt 144 to a reverse-osmosis station 146. At the reverse osmosis station 146, nanobubbles may be used to enhance the ability of the reverse-osmosis (RO) equipment to recover the reverse-osmosis permeate, and to further concentrate the metal salt.

In some embodiments, the monitoring system may include instructions that when executed cause the system 100 to process 150 the metal salt 148 into an alternative composition containing the metal. In some embodiments, the system 100 may use conventional techniques, for example converting a concentrated lithium chloride 148 salt to a concentrated lithium carbonate. Conventional techniques generally produce lithium carbonate from lithium chloride, water, and a carbon source. In some embodiments, the carbon source is provided by transmitting a signal to cause nanobubble equipment to produce gas nanobubbles. In some embodiments, the produced gas nanobubbles are of carbon dioxide gas produced within the water containing the concentrated lithium chloride 148. In some embodiments, the system 100 causes the nanobubble equipment to produce gas nanobubbles into the concentrated lithium chloride 148 without the use of other techniques to produce lithium carbonate.

In some embodiments the system 100 may be fully automated, semi-autonomous, or manually operated. While the system 100 has been described with use of large-format compositions for direct metal extraction, the nanobubble system may be applied throughout the metal-extraction process 110, the rinse step 120, and the elution step 130 in combination with other conventional direct-metal-extraction techniques. Similarly, several techniques may be used in conjunction with or instead of the aforementioned steps to separate the desired metal from the direct-extraction materials and/or rinsing agent. In some embodiments, the desired metal may be concentrated into the solution using one or more of forward osmosis, reverse osmosis, and selectively permeable membranes.

The exposure may occur at ambient temperature and ambient pressure. In some embodiments, the contact time allows the sorbent to make sufficient contact with the produced water, allowing the sorbent to sequester the metal from the produced-water volume. The contact time the produced water may be placed in contact with the sorbent may vary in time based on the reactivity of the sorbent and the constituents of the fluid. Large-format compositions in which a metal ion may occupy a space will actively extract the metal faster as the statistical probability of a metal ion encountering an unoccupied space within the large-format composition, e.g., an unoccupied space within a sorbent such as Li_{1.33}Mn_{1.67}O₄ or Li₄Mn₅O₁₂, is greatest when clean large-format composition comes in contact with the metal ion. In some embodiments, the produced water may have a reduced first contact time to quickly extract the desired concentration from the produced water. The produced water may then be transferred to a second station for batch processing where the contact time is fine-tuned to “finish” the extraction process.

When enough time has elapsed for the metal to have been removed from the produced water such that a desired concentration of metal within the produced water has been extracted, at the rinse step 120, the method may include removing the produced water from contact with the sorbent. Once a desired amount of produced water has been removed, at the elution step 130, the method may include rinsing the sorbent. After rinsing the sorbent, at the rinse step 140, the method may include exposing the rinsed sorbent to a reagent to produce at least one metal eluate.

In some embodiments, exposing the volume of produced water to a sorbent for a contact time 110 may be accomplished by batch processing the volume of produced water with the sorbent for the contact time. In some embodiments, batch processing the volume of produced water with the sorbent for the contact time further comprises mixing the volume of produced water with the sorbent for the contact time. In some embodiments, batch processing the volume of produced water with the sorbent for the contact time further comprises testing a concentration level of the at least one metal. In some embodiments, batch processing may be conducted in industrial equipment. In some embodiments, the equipment may be augmented with agitators and other mixing components and techniques to increase the opportunities for the sorbent to come in contact with the volume of produced water.

The contact time may be calculated, although, in some embodiments, the contact time may be based on a direct or an indirect measurement of the change in metal concentration within the system. In some embodiments, batch processing the volume of produced water with the sorbent for the contact time further comprises testing an indication of a concentration level of the at least one metal. In some embodiments, testing an indication of a concentration level of the at least one metal includes testing a pH level of the produced water. In some embodiments, exposing the volume of produced water to a sorbent for a contact time may further comprise continuous processing the volume of produced water with the sorbent for the contact time. Continuous processing may be monitored to ensure metal extraction occurs at the desired levels.

In some embodiments, continuous processing the volume of produced water with the sorbent for the contact time further comprises testing a concentration level of the at least one metal. In some embodiments, batch processing the volume of produced water with the sorbent for the contact time further comprises testing an indication of a concentration level of the at least one metal. In some embodiments, testing an indication of a concentration level of the at least one metal further comprises testing a pH level of the produced water.

In some embodiments, testing an indication of a concentration level of the at least one metal further comprises testing a flow rate of the produced water. In some embodiments, the sorbent may be a metal-oxide sorbent. In some embodiments, the metal-oxide sorbent may be doped. In some embodiments, the metal-oxide sorbent may be doped with an ion doping agent.

In some embodiments, an ion dopant may further comprise an ion doping agent. For a nonlimiting example of an ion doping agent, see Guotai Zhang, et al. “Al and F Ions Co-Modified li1.6mn1.6o4 with Obviously Enhanced Li+ Adsorption Performances.” Chemical Engineering Journal, Elsevier, 5 Jul. 2022, https://www.sciencedirect.com/science/article/abs/pii/S1385894722033988, the publication is hereby incorporated in its entirety by reference. In some embodiments, the metal-oxide sorbent may be a manganese oxide-based sorbent. In some embodiments, the manganese oxide-based sorbent may be doped. In some embodiments, the metal-oxide sorbent may be a manganese oxide-based sorbent that may further comprise a lithium manganese oxide (LMO). For a discussion of lithium manganese oxides (LMOs) in conjunction with direct lithium extraction (DLE) based on the chemistry of the produced water, see Calvo, Ernesto. (2021), Direct Lithium Recovery from Aqueous Electrolytes with Electrochemical Ion Pumping and Lithium Intercalation, ACS Omega, 10.1021/acsomega. 1c05516, which is hereby incorporated in its entirety by reference. In some embodiments, the metal-oxide sorbent may be a manganese oxide-based sorbent that may further comprise a lithium manganese oxide (LMO)-type lithium ion-sieve (LIS). For more information on LMO-type LIS, see Ding Weng al, et al. “Introduction of Manganese Based Lithium-Ion Sieve-A Review.” Progress in Natural Science: Materials International, Elsevier, 19 Mar. 2020, https://www.sciencedirect.com/science/article/pii/S1002007119304204, which is hereby incorporated in its entirety by reference.

In some embodiments, the lithium manganese oxide (LMO) may be doped. In some embodiments, the metal-oxide sorbent may be a titanate sorbent. In some embodiments, the titanate sorbent may be doped. In some embodiments, the metal-oxide sorbent may be an aluminate sorbent such as LiClAl₂(OH)₆nH₂O. In some embodiments, the aluminate sorbent may be doped. In some embodiments, the contact time may be a function of at least the volume of produced water, a sorbent surface area, and a desired extraction of the concentration of metal from the volume of produced water.

In some embodiments, the at least one metal may be an alkali metal. In some embodiments, the alkali metal may be lithium. In some embodiments, the lithium from the volume of produced water may be at an initial concentration equal to or less than or equal to 50 ppm. In some embodiments, the lithium from the volume of produced water may be at an initial concentration equal to or less than 50 ppm and greater than or equal to 3 ppm.

In some embodiments, the lithium from the volume of produced water may be at an initial concentration equal to or less than 100 ppm. In some embodiments, the contact time may be a function of at least the volume of produced water, the mass of sorbent, and a reduction in an initial pH of the produced water to a final pH of the produced water. In some embodiments, an initial pH of the produced water may be a pH less than or equal to 10.0 and greater than or equal to a pH of 5.0.

In some embodiments, a final pH of the produced water may be greater than or equal to a pH of 5.0. In some embodiments, the volume of produced water is exposed to the sorbent during the contact time. In some embodiments, the at least one metal from the volume of produced water may be an alkali metal. In some embodiments, the alkali metal from the volume of produced water may be lithium.

In some embodiments, an initial concentration of the lithium from the volume of produced water may be less than or equal to 50 ppm and greater than or equal to 10 ppm. In some embodiments, an initial concentration of the lithium from the volume of produced water may be greater than or equal to 10 ppm. In some embodiments, the method may include receiving the volume of produced water. In some embodiments, the volume of produced water may be received untreated from an oil-producing well.

In some embodiments, the volume of produced water may be received untreated from an oil-producing well. In some embodiments, the volume of produced water is pre-treated prior to exposing the volume of produced water to a sorbent for a contact time. In some embodiments, pre-treating the volume of produced water prior to exposing the volume of produced water to a sorbent for a contact time further comprises applying, to the produced water, one or more of a mechanical filter, a chemical filter, or a magnetic separation.

In some embodiments, rinsing the sorbent after the contact time elapses further comprises rinsing the sorbent with fresh water after the contact time. In some embodiments, the method may include returning the fresh water to one or more holding tanks. In some embodiments, the method may include performing reverse osmosis on the returned fresh water. In some embodiments, exposing the rinsed sorbent to a reagent to produce at least one metal eluate further comprises exposing the rinsed sorbent to an aqueous acid solution.

In some embodiments, exposing the rinsed sorbent to an aqueous acid solution further comprises exposing the rinsed sorbent to an aqueous solution of HCl. In some embodiments, exposing the rinsed sorbent to an aqueous solution of HCl further comprises producing a metal-chloride eluate. In some embodiments, producing a metal-chloride eluate further comprises producing a lithium-chloride eluate. In some embodiments, producing a lithium-chloride eluate further comprises removing the lithium-chloride eluate from the rinsed sorbent.

In some embodiments, the method may include receiving the volume of produced water. In some embodiments, receiving the volume of produced water further comprises receiving the volume of produced water at a wellhead, a saltwater disposal well, a produced-water storage facility, a retention pond, a frac pond, a flowback-fluid collection site, a retention pond, a holding tank, a holding pond, a pump station, a frac tank, and a water-midstream infrastructure site.

In some embodiments, receiving the volume of produced water further comprises pre-treating the produced water. In some embodiments, the volume of produced water further comprises pre-treated produced water. In some embodiments, pre-treating the produced water further comprises running the volume of produced water through a mechanical filter. In some embodiments, running the volume of produced water through a mechanical filter further comprises applying, to the volume of produced water, at least one of a sock filtration, a polymer filtration, or a clay filtration.

In some embodiments, pre-treating the produced water further comprises running the volume of produced water through a chemical filter. In some embodiments, pre-treating the produced water further comprises applying, to the produced water, a multiphase separator. In some embodiments, pre-treating the produced water further comprises applying, to the produced water, at least one of a heat treatment, gravity separation, centrifugal separation, nut shell filtration, and electrochemical separation.

In some embodiments, pre-treating the produced water further comprises applying, to the produced water, a chemical demulsifier. In some embodiments, pre-treating the produced water further comprises applying, to the produced water, a magnetic-separation treatment. In some embodiments, pre-treating the produced water further comprises applying, to the produced water, a magnetic-separation treatment. In some embodiments, pre-treating the produced water further comprises applying, to the produced water, at least one of a dissolved air flotation, a suspended air flotation, a diffused air flotation, an oxygen-induced air flotation.

In some embodiments, pre-treating the produced water further comprises applying, to the produced water, an oil skimmer. In some embodiments, pre-treating the produced water may further comprise plasma treating the volume of produced water. In some embodiments, pre-treating the produced water further comprises removing, from the produced water, at least one of a solid, oil, and H2S.

In some embodiments, pre-treating the produced water further comprises precipitating an iron-containing compound. In some embodiments, pre-treating the produced water further comprises adsorbing sodium from the produced water. In some embodiments, the method may include receiving the volume of produced water at a weir tank. In some embodiments, the at least one metal from the volume of water may be a compound containing or an ionic form of at least one of silver, aluminum, gold, boron, beryllium, bismuth, bromine, calcium, cadmium, chromium, cobalt, or copper.

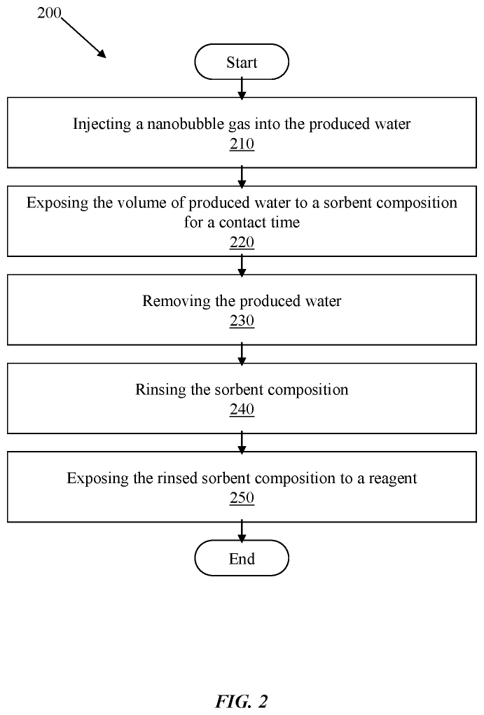

FIG. 2 is a flowchart 200 that describes a method for increasing the efficacy of reducing a concentration of an at least one metal from a volume of produced water, according to some embodiments of the present disclosure. In some embodiments, at 210, the method may include injecting a gas nanobubble into the volume of produced water. At 220, the method may include exposing the volume of produced water to a sorbent composition for a contact time. At 230, the method may include removing the produced water after the contact time elapses. At 240, the method may include rinsing the sorbent composition after the cycle time. At 250, the method may include exposing the rinsed sorbent composition to a reagent to produce at least one metal eluate. The sorbent composition may be a large format composition (e.g., a sorbent of at least 250 microns in dimension), a doped sorbent, an undoped sorbent, a coated sorbent, a homogeneous sorbent, a heterogeneous sorbent, or any combination thereof.

In some embodiments, injecting a gas nanobubble into the volume of produced water further comprises using a high-capacity nanobubble system to produce gas nanobubbles in the volume of produced water. In some embodiments, injecting a gas nanobubble into the volume of produced water further comprises injecting a neutrally-buoyant gas bubble. The neutrally-buoyant gas bubble may have a diameter greater than 25 nanometers and less than 250 nanometers.

In some embodiments, injecting a gas nanobubble into the volume of produced water further comprises injecting a plurality of electrochemically active gas bubbles. In some embodiments, injecting a gas nanobubble into the volume of produced water further comprises injecting oxygen (O₂) gas nanobubbles into the volume of produced water. In some embodiments, injecting a gas nanobubble into the volume of produced water further comprises injecting air gas nanobubbles into the volume of produced water.

In some embodiments, injecting a gas nanobubbles into the volume of produced water further comprises injecting carbon dioxide (CO₂) gas nanobubbles into the volume of produced water. In some embodiments, injecting a gas nanobubble into the volume of produced water further comprises injecting nitrogen (N₂) gas nanobubbles into the volume of produced water. In some embodiments, a gas nanobubble further comprises at least one of an O₂, Air, CO₂, N₂ gas.

In some embodiments, the produced water may be any water produced concurrently with a production of oil and gas hydrocarbons from underground reservoirs or subterranean flows, including, but not limited to, naturally occurring formation water, flowback water, recycled water, and water injected into reservoirs during hydraulic fracturing or other injection methods. In some embodiments, exposing the volume of produced water to a large-format composition for a contact time further comprises batch processing the volume of produced water with the large-format composition for the contact time.

In some embodiments, exposing the volume of produced water to a large-format composition for a contact time may further comprise continuous processing the volume of produced water with the large-format composition for the contact time. In some embodiments, the contact time may be a function of at least the volume of produced water, an initial mass of the large-format composition, and a desired parts per million (ppm) removal of the metal.

In some embodiments, a sorbent composition may be a metal-oxide sorbent. In some embodiments, the metal-oxide sorbent may comprise a spinel chemical structure. In some embodiments, the metal-oxide sorbent may be doped with an ion doping agent. In some embodiments, the metal-oxide sorbent may be doped. In some embodiments, the metal-oxide sorbent may be a manganese oxide-based sorbent. In some embodiments, the manganese oxide-based sorbent may be doped.

In some embodiments, the manganese oxide-based sorbent may further comprise a lithium manganese oxide (LMO). In some embodiments, the manganese oxide-based sorbent may further comprise a lithium-manganese-oxide (LMO)-type lithium ion-sieve (LIS). In some embodiments, the lithium manganese oxide (LMO) may be doped. In some embodiments, the metal-oxide sorbent may be a titanate sorbent such as Li₄Ti₅O₁₂ or Li7Ti5O12. In some embodiments, the metal-oxide sorbent may be an aluminate sorbent. In some embodiments, the titanate sorbent may be doped with at least one cation. In some embodiments, the cation may be Mg2+, Sn2+, Zn2+, Al3+, Cr3+, Sn4+, Zr4+, Ru4+, V5+, Nb5+, or the like.

In some embodiments, the aluminate sorbent may be doped. In some embodiments, rinsing the large-format composition with an aqueous solution includes where the aqueous solution may be at least one of fresh water, deionized water, and a nanobubble-infused water. In some embodiments, removing the produced water after the contact time may elapse further comprises flowing the produced water through a selectively permeable membrane.

In some embodiments, removing the produced water after the contact time may elapse further comprises conducting one or more of a primary separation, a secondary separation, and a polishing filtration. In some embodiments, rinsing the large-format composition after the cycle time further comprises rinsing the sorbent with fresh water after the contact time. In some embodiments that include rinsing the sorbent with fresh water after the contact time, the fresh water further comprises fresh water containing nanobubbles of oxygen (O₂), air, carbon dioxide (CO₂), or nitrogen (N₂) gas. In some embodiments, exposing the rinsed large-format composition to a reagent to produce at least one metal eluate further comprises returning the fresh water to one or more holding tanks. In some embodiments, returning the fresh water to one or more holding tanks further comprises performing reverse osmosis on the returned fresh water.

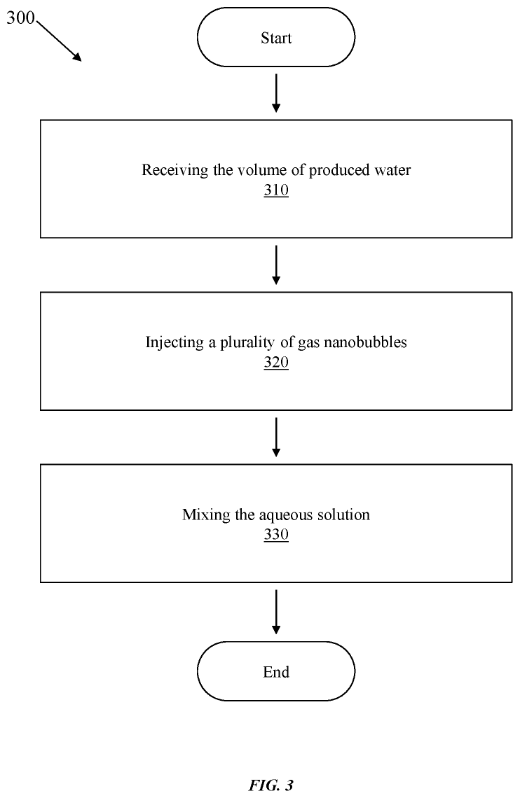

FIG. 3 is a flowchart 300 that further describes the method for increasing the efficacy of reducing a concentration of an at least one metal from a volume of produced water from FIG. 2, according to some embodiments of the present disclosure. In some embodiments, injecting a volume of gas nanobubble into the volume of produced water may occur at one or more steps in the direct metal extraction process. In some embodiments, the volume of gas nanobubbles may occur at when receiving a metal containing fluid, exposing the metal containing fluid to a sorbent, and various methods to purify the metal containing fluid or reduce the volume of water present in a metal containing fluid or eluant. Injecting a volume of gas nanobubbles may be accomplished by first receiving the volume of produced water 310. Upon receiving the volume of produced water 310, the volume of gas nanobubbles may be directly injected 320 into the volume of produced water or injected into another aqueous solution. In some embodiments, a substantially uniform distribution of gas nanobubbles is desired throughout the volume of produced water 310. In such embodiments, it is advantageous to mix the aqueous solution 330.

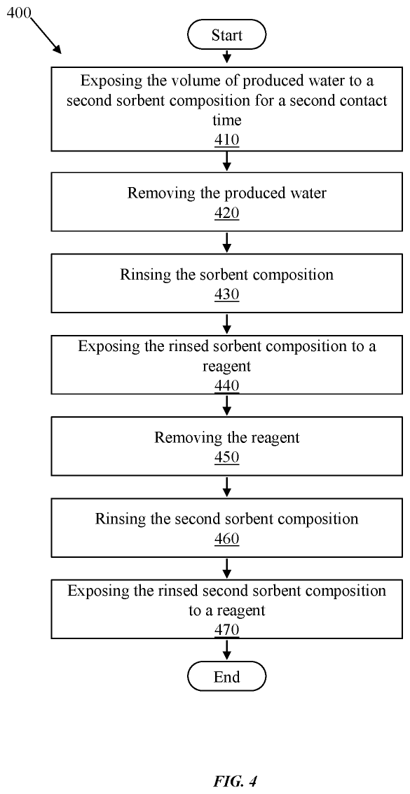

FIG. 4 is a flowchart 400 that further describes the method for increasing the efficacy of reducing a concentration of an at least one metal from a volume of produced water from FIG. 2, according to some embodiments of the present disclosure. In some embodiments, the produced water removed from the system, described with regard to FIG. 1, may be further processed or treated to reduce the metal concentration, or the produced water may be further processed to reduce the concentration of a second metal. In some embodiments, the method of selectively removing a desired metal may be aided by use of nanobubbles.

In some embodiments, at 410, the produced water recovered from the method of FIG. 2 is exposed to a second sorbent composition for a second contact time. In some embodiments, the second contact time varies from the first contact time associated with the first sorbent composition. In some embodiments, at 420, the produced water is removed from the second sorbent composition. In some embodiments, removing the produced water after the contact time elapses further exposes the produced water's volume to a second sorbent for a second contact time.

In some embodiments, at 430, the method may include rinsing the sorbent composition. Rinsing the sorbent composition removes excess produced water while preserving the desired metal within the sorbent composition. In some embodiments, the sorbent composition is a lithium manganese oxide (LMO) spinel. The lithium manganese oxide (LMO) spinel is rinsed with fresh water to remove excess produced water. For an expanded summary of the benefits of the use of nanobubbles, see Azevedo, H. Oliveira, J. Rubio, “Bulk nanobubbles in the mineral and environmental areas: Updating research and applications, Advances in Colloid and Interface Science,” Volume 271, 2019, 101992, ISSN 0001-8686, https://doi.org/10.1016/j.cis.2019.101992, herein incorporated in its entirety by reference to the extent the principles are consistent with the present disclosure. Once rinsed, the desired metal may remain within the rinsed lithium manganese oxide (LMO) spinel.

In some embodiments, the desired metal may be removed or otherwise extracted from the sorbent composition, at 440, by exposing the rinsed sorbent composition to a reagent. In some embodiments, the reagent may be an acid, for example, hydrochloric acid (HCl). In an embodiment in which the metal of interest is lithium, exposure of the sorbent composition, for example a rinsed lithium manganese oxide (LMO) spinel, to the reagent, for example, an acid like H₂SO₄, will produce LiSO₄, allowing the Li SO₄ to be subsequently removed from the sorbent composition. Of note, the reagent may be mixed in various concentration levels. Once the metal has reacted with the reagent, a rinsing agent may remove the desired metal from the sorbent.

In some embodiments, at 440, the holding tank may be adapted to use back-pressure or a vacuum to support the removal of the desired metal from the sorbent composition. In some embodiments, the desired metal will be released into the reagent from the sorbent composition. At 450, the reagent, for example an aqueous solution along with ionic forms of the desired metal of choice are removed.

In some embodiments, removing the produced water after the contact time may elapse further comprises exposing the volume of produced water to a second sorbent composition for a contact time. At 460, the method may include rinsing the second sorbent composition after the contact time. At 470, the method may include exposing the rinsed second sorbent to a reagent to produce at least one metal eluate.

In some embodiments, the rinsing agent may be infused with gas nanobubbles, for example, the rinsing agent may be water infused with gas nanobubbles. In some embodiments, the method may include receiving the volume of produced water. In some embodiments, the volume of produced water may be received untreated. In some embodiments, the volume of produced water may be pre-treated prior to exposing the volume of produced water to a sorbent composition for a contact time.

In some embodiments, pre-treating the volume of produced water prior to exposing the volume of produced water to a sorbent composition for a contact time further comprises applying, to the volume of produced water, one or more of a mechanical filter, a chemical filter, or a magnetic separation. In some embodiments, pre-treating the volume of produced water prior to exposing the volume of produced water to a sorbent composition for a contact time further comprises applying a plasma treatment to the volume of produced water.

In some embodiments, pre-treating the volume of produced water prior to exposing the volume of produced water to a sorbent composition for a contact time further comprises injecting a gas nanobubble into the volume of produced water. In some embodiments, rinsing after the cycle time further comprises rinsing the sorbent composition with fresh water after the cycle time. In some embodiments, the method may include returning the fresh water to one or more holding tanks.

In some embodiments, rinsing with a rinsing agent after the cycle time further comprises rinsing the sorbent composition with fresh water infused with gas nanobubbles after the cycle time. In some embodiments, the method may include returning the fresh water infused with gas nanobubbles to one or more holding tanks. In some embodiments, the method may include performing reverse osmosis on the returned fresh water. In some embodiments, performing reverse osmosis on the returned fresh water further comprises aiding the performed reverse osmosis with gas nanobubbles.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

Those having ordinary skill in the art will recognize that the state of the art has progressed to the point where there is little distinction left between hardware, software, and/or firmware implementations of aspects of systems; the use of hardware, software, and/or firmware is generally a design choice representing cost vs. efficiency tradeoffs (but not always, in that in certain contexts the choice between hardware and software can become significant). Those having ordinary skill in the art will appreciate that there are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be affected, none of which is inherently superior to the other in that any vehicle to be utilized is a choice dependent upon the context in which the vehicle will be deployed and the specific concerns (e.g., speed, flexibility, or predictability) of the implementer, any of which may vary.

In some implementations described herein, logic and similar implementations may include software or other control structures suitable to operation. Electronic circuitry, for example, may manifest one or more paths of electrical current constructed and arranged to implement various logic functions as described herein. In some implementations, one or more medias are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively, or additionally, in some variants, an implementation may include special-purpose hardware, software, firmware components, and/or general-purpose components executing or otherwise controlling special-purpose components. Specifications or other implementations may be transmitted by one or more instances of tangible or transitory transmission media as described herein, optionally by packet transmission or otherwise by passing through distributed media at various times.

Alternatively, or additionally, implementations may include executing a special-purpose instruction sequence or otherwise operating circuitry for enabling, triggering, coordinating, requesting, or otherwise causing one or more occurrences of any functional operations described above. In some variants, operational or other logical descriptions herein may be expressed directly as source code and compiled or otherwise expressed as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar modes of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those having ordinary skill in the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a USB drive, a solid state memory device, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic), etc.).

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read-only)), and/or electrical circuitry forming a communications device (e.g., a modem, communications switch, optical-electrical equipment). Those having ordinary skill in the art will recognize that the subject matter described herein may be implemented in an analog or digital fashion or some combination thereof.

Those skilled in the art will recognize that at least a portion of the devices and/or processes described herein can be integrated into a data processing system. Those having ordinary skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

In certain cases, use of a system or method as disclosed and claimed herein may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory.

Further, implementation of at least part of a system for performing a method in one territory does not preclude use of the system in another territory.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

One skilled in the art will recognize that the herein described components (e.g., operations), devices, objects, and the discussion accompanying them are used as examples for the sake of conceptual clarity and that various configuration modifications are contemplated. Consequently, as used herein, the specific examples set forth and the accompanying discussion are intended to be representative of their more general classes. In general, use of any specific example is intended to be representative of its class, and the non-inclusion of specific components (e.g., operations), devices, and objects should not be taken to be limiting.

With respect to the use of substantially any plural and/or singular terms herein, those having ordinary skill in the art can translate from the plural to the singular or from the singular to the plural as is appropriate to the context or application. The various singular/plural permutations are not expressly set forth herein for sake of clarity.

The herein described subject matter sometimes illustrates different components contained within, or connected with, different other components. It is to be understood that such depicted architectures are presented merely as examples, and that in fact many other architectures may be implemented which achieve the same functionality. In a conceptual sense, any arrangement of components to achieve the same functionality is effectively “associated” such that the desired functionality is achieved. Therefore, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of “operably couplable” include but are not limited to physically mateable or physically interacting components, wirelessly interactable components, wirelessly interacting components, logically interacting components, or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components, inactive-state components, or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such a recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having ordinary skill in the art would understand the convention (e.g., “a system having at least one of A, B, and C” would include but not be limited to systems that have A alone, B alone, C alone, A and B together, A and C together, B and C together, and/or A, B, and C together). In those instances where a convention analogous to “at least one of A, B, or C, etc.” is used, in general such a construction is intended in the sense one having ordinary skill in the art would understand the convention (e.g., “a system having at least one of A, B, or C” would include but not be limited to systems that have A alone, B alone, C alone, A and B together, A and C together, B and C together, and/or A, B, and C together). It will be further understood by those within the art that typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented as sequences of operations, it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1.-94. (canceled)

95. A method for reducing a concentration of lithium from a volume of produced water, the method comprising:
a. exposing the volume of produced water to a sorbent contained within a mechanical filter for a contact time, wherein the exposure occurs in less than 50 degrees Celsius and less than 3 atmospheres of pressure;
b. removing the volume of produced water from the sorbent contained within the mechanical filter after the contact time elapses;
c. rinsing the sorbent contained within the mechanical filter after the contact time elapses; and
d. exposing the rinsed sorbent to a reagent to produce a lithium eluate.

96. The method of claim 95, wherein exposing the volume of produced water to a sorbent contained within a mechanical filter for a contact time further comprises batch processing the volume of produced water with the sorbent for the contact time.

97. The method of claim 96, wherein treating the produced water further comprises:
a. exposing the volume of produced water to a media bed containing the sorbent for an additional contact time;
b. removing the produced water from the media bed containing the sorbent after the contact time elapses;
c. rinsing the media bed containing the sorbent after the contact time elapses; and
d. exposing the rinsed sorbent to a reagent to produce a metal eluate.

98. method of claim 97, wherein exposing the volume of produced water to the media bed containing the sorbent for an additional contact time further comprises exposing the volume of produced water to an additional media bed within an additional vessel filtration containing the sorbent for the additional contact time.

99. The method of claim 95, wherein treating the produced water further comprises polishing the produced water.

100. The method of claim 96, wherein mixing the volume of produced water with the sorbent for the contact time, further comprises running the volume of produced water through a media bed containing the sorbent.

101. The method of claim 100, wherein the sorbent further comprises a lithium manganese oxide (LMO), a lithium ion-sieve (LIS), a titanate sorbent, or an aluminate sorbent.

102. The method of claim 100, wherein the lithium from the volume of produced water is at an initial concentration less than 50 ppm.

103. The method of claim 101, wherein the sorbent is doped with at least one of Mg²⁺, Sn²⁺, Zn²⁺, Al³⁺, Cr³⁺, Sn⁴⁺, Zr⁴⁺, Ru⁴⁺, V⁵⁺, and Nb⁵⁺.

104. The method of claim 95, wherein exposing the volume of produced water to a sorbent contained within a mechanical filter for a contact time, further comprises continuous processing the volume of produced water through a media bed containing a sorbent.

105. The method of claim 104, wherein the sorbent further comprises a doped lithium manganese oxide (LMO).

106. The method of claim 105, wherein exposing the volume of produced water to a sorbent contained within a mechanical filter for a contact time further comprises continuous processing the volume of produced water with through the media bed containing the doped lithium manganese oxide (LMO) for the contact time.

107. A method for reducing a concentration of an at least one metal from a volume of produced water, the method comprising:
a. exposing the volume of produced water to a large-format composition within a media bed for a contact time;
b. removing the produced water from the media bed after the contact time elapses;
c. rinsing the large-format sorbent after the contact time elapses; and
d. exposing the rinsed large-format sorbent sorbent to a reagent to produce at least one metal eluate.

108. The method of claim 107, wherein exposing the volume of produced water to a large-format composition for a contact time further comprises exposing the volume of produced water to the large-format composition using batch processing.

109. The method of claim 108, wherein the volume of produced water comprises a naturally occurring water that emerges from a subterranean source during a process that at least produces a hydrocarbon by-product.

110. The method of claim 107, wherein exposing the volume of produced water to a large-format composition for a contact time further comprises exposing the volume of produced water to the large-format composition using continuous processing.

111. The method of claim 110, wherein the volume of produced water further comprises a wastewater associated with an oil and gas exploration, an oil and gas development, or an oil and gas production activity.

112. A method for reducing a concentration of an at least one metal from a volume of produced water, the method comprising:
a. exposing the volume of produced water to a large-format composition for a contact time;
b. removing the produced water from the large-format composition after the contact time elapses; and
c. rinsing the large-format composition with a reagent to produce at least one metal eluate.

113. The method of claim 112, wherein the large-format composition further comprises a lithium manganese oxide (LMO), a lithium manganese oxide (LMO)-type lithium ion-sieve (LIS), a titanate sorbent, an aluminate sorbent.

114. The method of claim 113, wherein removing the produced water after the contact time elapses further comprises:
a. exposing the volume of produced water to a large-format composition for a second contact time, wherein the large-format composition is doped with at least one of Mg²⁺, Sn²⁺, Zn²⁺, Al³⁺, Cr³⁺, Sn⁴⁺, Zr⁴⁺, Ru⁴⁺, V⁵⁺, and Nb⁵⁺;
b. removing the produced water after the contact time elapses; and
c. exposing the large-format composition to an aqueous solution of HCl or H₂SO₄ to produce at least a lithium chloride eluate or a lithium sulfate eluate.
